(19) United States
(12) Patent Application Publication
(10) Pub. No.: US 2016/0378691 A1
(43) Pub. Date: Dec. 29, 2016

(54) SYSTEM, APPARATUS AND METHOD FOR PROTECTING A STORAGE AGAINST AN ATTACK

(71) Applicant: Intel Corporation, Santa Clara, CA (US)

(72) Inventor: Brent M. Sherman, Portland, OR (US)

(21) Appl. No.: 14/749,832

(22) Filed: Jun. 25, 2015

(51) Int. Cl. G06F 12/14

(52) U.S. Cl. CPC G06F 12/1425; G06F 2212/1052

(57) ABSTRACT

In one embodiment, an apparatus includes a storage controller to couple to a storage device. The storage controller may include a first counter to maintain a first count of incoming read requests to the storage device, a second counter to maintain a second count of incoming write requests to the storage device, and a workload analysis logic to calculate a workload ratio based at least in part on the first count and the second count, compare the workload ratio to an estimated workload ratio, and issue a tamper alert based at least in part on the comparison. Other embodiments are described and claimed.

### TECHNICAL FIELD

Embodiments relate to security in computer systems.

### BACKGROUND

Hacking or other security breaches of data centers and other computing systems and the corresponding stealing of information has become a regular occurrence. The financial and privacy impacts of these data breaches are severe enough that information technologists (IT) are frantically searching for new protection mechanisms. Early detection of such malicious activity can reduce impact. To date, protection measures often fall short, while at the same time increasing computing complexity, delaying processing and creating other undesired impacts.

This situation occurs in part due to the complexity of computer systems and data centers having multiple operating systems, services, applications, and so forth, which makes it is difficult to prevent and/or detect malicious attacks. In addition, a hacker has many attack points at his disposal. Current protections, even at a supervisor level, can easily be compromised. Once compromised, mitigation is typically via a software patch, which could take days or weeks to deploy. By this time it is too late, and the hacker has already retrieved the data in question.

### BRIEF DESCRIPTION OF THE DRAWINGS

FIG. 1 is a block diagram of a computing system in accordance with an embodiment of the present invention.

FIG. 2 is a block diagram of a controller in accordance with an embodiment of the present invention.

FIG. 3 is a flow diagram of a method in accordance with an embodiment of the present invention.

FIG. 4 is a block diagram of a system arrangement in accordance with an embodiment of the present invention.

FIG. 5 is a block diagram of another example system with which embodiments can be used.

FIG. 6 is a block diagram of a system in accordance with another embodiment of the present invention.

### DETAILED DESCRIPTION

In various embodiments, techniques are provided to enable detection of malicious activity on a computing system and protect data associated with the system at a level of a given storage device such as a solid-state drive (SSD). In one particular implementation, for a determined workload on a data server, a storage controller associated with a storage device can count read/write requests and calculate a workload ratio between the read and write requests and compare this calculated ratio with an expected workload ratio associated with the workload. If these ratios are not equivalent (or at least within a given tolerance or threshold of each other), the system can be considered to be compromised and one or more security policies may be enforced.

More specifically, in one embodiment the storage controller may be implemented at least in part via a Serial Advanced Technology Attachment (SATA) controller firmware, which is part of a trusted computing base (TCB) of a system. Responsive to detection of a variance in these ratios, the storage system associated with this controller (such as an SSD) may be placed into a protected mode. In this case, since the detection and protection mechanisms are in the trusted computing base, they are immutable by an unauthorized user. Also this technique may be implemented within the path of normal operation such that the overhead and expense of an add-on monitoring agent (such as device or software) that observes traffic can be avoided.

One example use case is in connection with a server having a predictable workload due to its specific use cases. For example, a server handling credit card transactions will see more writes (transactions being created) than reads (transactions being analyzed) under normal conditions. Another example of a predictable workload use case is an automated teller machine (ATM) server. This type of server typically sees an increase in data reads before the end of the month as users check their balance before rent/mortgage is due. In these and other scenarios, an imbalance in an expected read/write ratio can be used to detect malicious activity.

Embodiments provide a detection technique that is performed in real time such that every input/output (I/O) request associated with a storage device is verified automatically without any aid. Embodiments thus can prevent malicious activity if the detection technique is configured with, e.g., a low read/write count and ratio tolerance, as verification is done before an I/O request reaches the data residing on the storage.

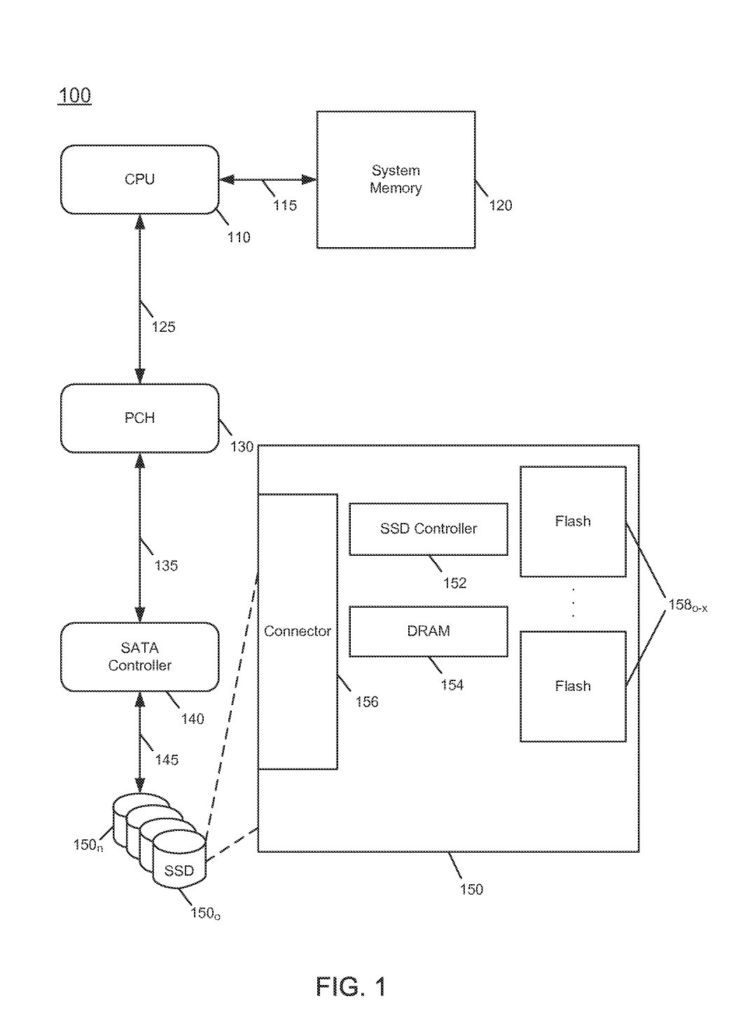

Referring now to FIG. 1, shown is a block diagram of a computing system in accordance with an embodiment of the present invention. As shown in FIG. 1, system 100 may be any type of computing system depending on environment. For example, system 100 may be a user computer system, ranging from a small portable device, such as smartphone, tablet computer, laptop computer or so forth, to a desktop user computer. Still further in other cases, system 100 may be a server computer, e.g., implemented as a blade or other server configured in a cabinet with other such servers.

As illustrated in FIG. 1, system 100 includes a processor 110 (also referred to herein as a central processing unit (CPU)). In different embodiments, processor 110 may be given a multi-core processor or other system on chip (SoC). Various software, including user-level software (referred to also as a ring-3 software) such as user applications, and supervisor-level software (referred to as ring-0 software) such as an operating system, hypervisor, firmware, or other supervisor software, may execute on processor 110. As seen, processor 110 couples to a system memory 120 which, in an embodiment may be implemented as one or more dynamic random access memories (DRAM). As seen, interconnection between processor 110 system memory 120 may be via a memory interconnect 115.

As further illustrated, processor 110 may couple to a peripheral controller hub (PCH) 130 via a peripheral interconnect 125. Although shown as a separate component in the illustration of FIG. 1, in some cases PCH 130 may be implemented within a processor package with processor 110 (and in some cases PCH 130 may be implemented on a single semiconductor die with the rest of processor 110). In turn, PCH 130 couples via an interconnect 135 (which in an embodiment may be a Peripheral Component Interconnect Express (PCIe) interconnect 135 with a SATA controller 140. SATA controller 140 may be configured to translate incoming requests from upstream into a format for accessibility to a downstream storage system.

In the embodiment shown, this downstream storage system may be implemented as a set of data storage devices 150₀-150ₙ which, in the embodiment of FIG. 1, is implemented as a set of solid-state drives (SSDs). Of course in other cases, data storage devices may take many different forms, including a variety of known mass storage devices such as disk drives, other flash memories, optical storage, ferroelectric storage, magnetic storage, ovonic storage, phase change storage, among many other storage technologies.

In the embodiment shown, however, data storage devices 150 are implemented as a set of solid state drives 150. As further seen, a representative drive 150 is shown to include a SSD controller 152, details of which are described further below. Suffice to say, SSD controller 152 may be configured to act as a main processor for the SSD and provide an interface for communication between SATA controller 140 and a particular storage device, which as shown may be implemented as a set of flash memories 158₀-158ₓ. As further shown, SSD 150 may include a memory 154, which may be a DRAM to provide storage for use by SSD controller 152. As further seen, a connector 156 may provide for interconnection of SATA and power lines between SATA controller 140 and SSD 150. Understand while shown at this high level in the embodiment of FIG. 1, many variations and alternatives are possible.

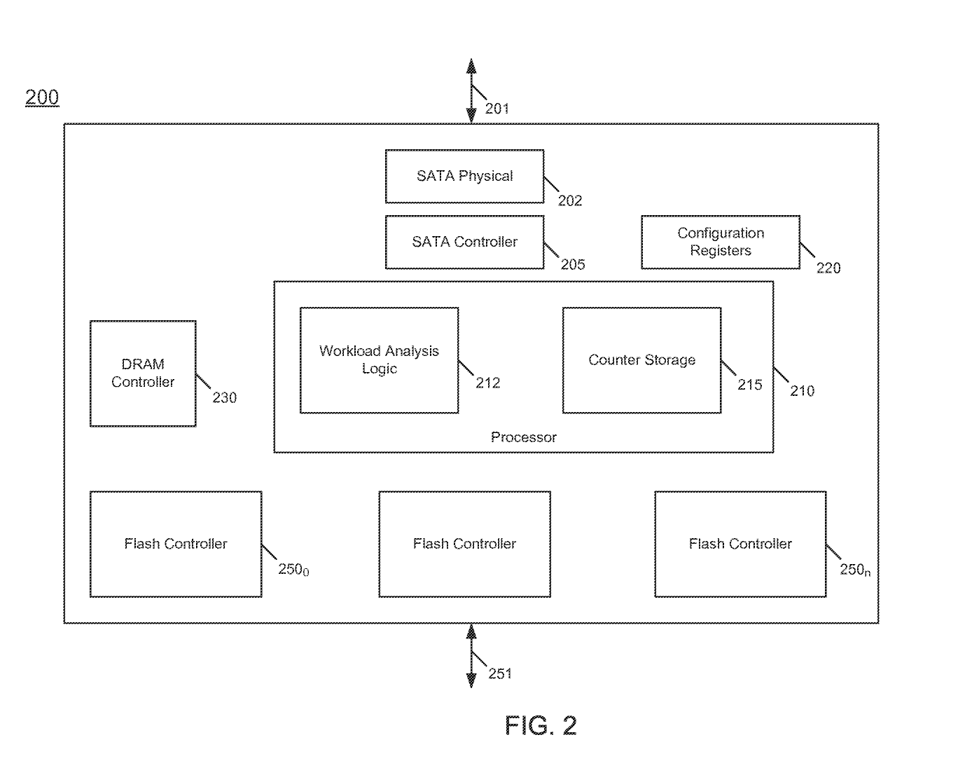

Referring now to FIG. 2, shown is a block diagram of a SSD controller in accordance with an embodiment of the present invention. Understand that while shown in FIG. 2 as an SSD controller 200, in other arrangements a storage controller may similarly be configured to provide for control and interface of a given data storage device with which the controller is associated.

As shown in FIG. 2, controller 200 communicates via a SATA interface 201 on an upstream side and via a downstream interface 251 with particular flash memories of the SSD on a downstream side. A SATA physical (PHY) unit 202 processes the communications in the upstream and downstream directions via interface 201 and provides incoming communications via a SATA controller 205 to a processor 210. In an embodiment, processor 210 may be a given embedded processor, which may be implemented as a microcontroller configured to execute firmware (which may be stored in the microcontroller itself or otherwise stored in a non-volatile storage). As seen, processor 210 includes a workload analysis logic 212, details of which are described further herein. Processor 210 further includes a counter storage 215, which in an embodiment may provide for storage of various count information as described herein. To aid in execution of operations with regard to the storage, processor 200 may include a set of configuration registers 220. As will be described herein a number of these configuration registers may be used to configure the SSD controller to perform workload analysis-based security measures.

Still with reference to FIG. 2, processor 200 further includes a DRAM controller 230 that provides an interface to an off-chip DRAM (not shown for ease of illustration in FIG. 2). In addition, a plurality of flash controllers 250₀-250ₙ interface with particular flash memory devices of the SSD. Understand while shown at this high level in the illustration of FIG. 2, many variations and alternatives are possible.

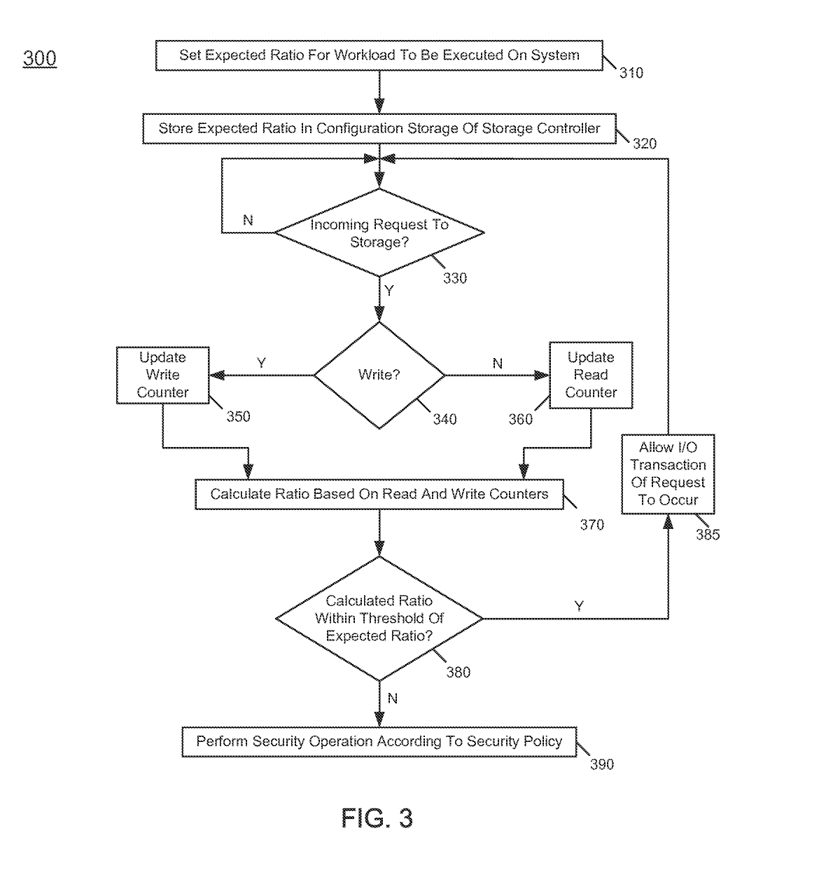

Referring now to FIG. 3, shown is a flow diagram of a method in accordance with an embodiment of the present invention. In different implementations, method 300 may be performed by appropriate combinations of hardware, software, and/or firmware. In one particular embodiment, method 300 may be performed by a SSD controller of an SSD that acts as a data storage device for a given computing environment. As illustrated, method 300 begins by setting an expected ratio for a workload to be executed on the system (block 310). In an embodiment, an authorized user such as a system administrator may provide a command to enable this expected ratio to be set. Note that in many cases, the authorized user may first be authenticated to the SSD controller, e.g., by way of a password or other secure login process to enable input of this command. As described herein, this expected ratio may be for a particular workload that is configured on the computing system, such as processing of credit card transactions or so forth. Control next passes to block 320 where this expected ratio may be stored in a configuration storage of the storage controller. In an embodiment, the SSD controller may set a value in a given configuration register to the value of the expected ratio.

At this point, the storage controller is set to begin the workload analysis. Understand that in a given embodiment, a variety of other configuration information may be provided by the authorized user. For example, the workload analysis operations may be enabled for certain workloads and/or certain time periods and disabled for other workloads/times. Still further, in some cases such measures can be enabled for only certain locations within a corresponding data storage device (such as one or more given logical block address (LBA) ranges or so forth). In still further embodiments, the workload analysis operations may be enabled as appropriate depending on workload or other conditions.

In any case still with reference to FIG. 3, control passes from block 320 to diamond 330 where it can be determined whether an incoming request to the storage device is received. If so, control passes to diamond 340 to determine whether the incoming request is a write request. If so, control passes to block 350 where a write counter may be updated. Otherwise, the incoming request is considered to be a read request, and accordingly control passes to block 360 where a read counter may be updated. Of course understand that in another convention, it can be determined whether an incoming request is a read and appropriate updating of a given read or write counter can be made based on that determination.

In either case, control passes to block 370 where a ratio may be calculated based on the values of these read and write counters. In different implementations, a selected one of the counter values may act as the numerator and the other counter value may act as the denominator. Next at diamond 380 it is determined whether this calculated ratio is within at least a threshold level of an expected ratio. In various embodiments, this threshold level may be set by the authorized user with reference to a threshold encoding in a configuration register (note that the threshold may be zero, in some cases and can range upward to a desired level). If it is determined that the calculated ratio of reads and writes is within the expected ratio, control passes to block 385 where the given I/O transaction of the incoming request may be allowed to occur. As such, this transaction can be sent from the storage controller to the data storage device (e.g., to a given one of multiple flash memories of the SSD) to fulfill the request.

Still with reference to FIG. 3, if instead the calculated ratio is not within this threshold level, control passes to block 390 where one or more security operations may be performed according to a given security policy. Note that this security policy itself may be stored in one or more of the configuration registers or other location (such as within firmware of the storage controller). As one example security policy, the I/O transaction may be prevented from being allowed access to the memory and as such, the transaction is denied. Note that this denial of service of the transaction may or may not be communicated to a requester of the transaction.

In this or another embodiment, a tamper alert flag may be raised and communicated, e.g., to the authorized user such as a system administrator or user of the system. At this point and depending on policy, further incoming requests may not be allowed to be processed and passed to the data storage device. That is, in such cases, the user may take an affirmative action, such as resetting this tamper alert flag within a configuration register of the storage controller before normal operation is allowed to continue.

Note that in some cases, the read and write counters values are ever incrementing, at least until a maximum value of the counters is reached (which in an embodiment may be 32-bit counters). In other cases, these counters may be reset at predetermined time intervals which may be days, weeks or months, or otherwise may be reset such as when a user identifies that a new workload is to be provisioned on a computing system. While shown with this particular implementation in the embodiment of FIG. 3, understand that many variations and alternatives are possible.

In some systems with a complex architecture, operating systems and/or hypervisors can create unpredictable event noise. In some cases, an event manager could disable such events when the protections described herein are enabled. In addition, if an event is deemed noisy, an event handler for the event can pause/resume the detection described herein.

In an embodiment, an alert monitor can be configured to poll the tamper alert detection, at least in an embodiment in which no denial of service occurs when the calculated ratio varies from the expected workload.

In one particular embodiment in which a server provides storage by one or more associated SSDs, logic of a controller for the SSD can be leveraged, as this logic has access to and can analyze every read/write request made to the SSD. By keeping a rolling count of these requests, the logic can determine a current ratio (e.g., of reads to writes) and compare it to an expected workload ratio. If there is a discrepancy, the logic may identify that a tamper has occurred and take one or more appropriate measures. Since this logic (which in an embodiment may be implemented at least in part using firmware of an SSD controller) is protected from software (including ring-0 software) and is in an authenticated base (e.g., a TCB), it is immutable by an unauthorized user. Note also that if an adversary were to gain physical access to the storage device and swap it into another system, the control logic described herein will still prevent access to the stored data. The only way to gain access is to either bypass the storage controller by opening up the device or providing the correct master password within allotted attempts configured for the device.

To configure the controller and logic for the workload analysis and intrusion detection described herein, an authorized user (such as a system administrator or system owner) sets an expected read/write ratio in the SSD controller. In one embodiment, a vendor specific command may be provided as part of a Self Monitoring Analysis and Reporting Technology (SMART) feature set for a storage device. As one such example this command can be listed in the T13/1699-D ATA/ATAPI Command Set (ATA8-ACS). In an embodiment, a process for determining whether the user is authorized may leverage the ATA command SECURITY PASSWORD.

After configuration and during normal operation, the SSD controller firmware (assuming enabled and active for a particular workload and/or address range of the storage) may count read and write requests and calculate the current workload ratio. If it is determined that the current ratio is not at least within a threshold level of the expected ratio, the logic may (depending on configuration) enter into a protected mode, which blocks all read and write logical block address (LBA) requests.

In an embodiment, this protected mode is persisted across power cycles by storing state in a state storage. Optionally, according to a given security policy, an interrupt can be sent (e.g., from a general purpose input output pin (GPIO)) to a baseboard controller (BMC) for a server, which has the ability to notify the system administrator of the tamper alert. In some embodiments, to remove the storage device from protected mode and into a normal operating mode, an authorized user sends a vendor specific command, e.g., of the SMART feature set.

In an embodiment, a command may be provided in the SMART feature set to set an expected workload ratio. Table 1 below is a command encoding in accordance with an embodiment of the present invention.

TABLE 1

| Word | Name | Description |
|---|---|---|
| 00h | Feature | E0h - SMART WORKLOAD RATIO SETUP |
| 01h | Enable | Bit Description: |
| | | [0] - 0 disable, 1 enable |
| | | [15:1] - reserved |
| 02h | Read Count | Bit Description: |
| | | [15:0] - read byte count. If zero, workload |
| | | detection is disabled regardless of word 01h |
| 03h | Write Count | Bit Description: |
| | | [15:0] - write byte count. |
| | | If zero, workload detection is disabled |
| | | regardless of word 01h |
| 04h | Ratio | Bit Description: |
| | Tolerance | [2:0] - The workload ratio is not to exceed |
| | | the following % tolerance (+/−). Values: |
| | | 0h - 0% |
| | | 1h - 3% |
| | | 2h - 5% |
| | | 3h - 7% |
| | | 4h - 10% |
| | | 5h - 12% |
| | | 6h - 15% |
| | | 7h - 20% |
| | | [15:3] - reserved |
| 05h- | Lower LBA | Bit Description: |
| 09h | Bound | [48:0] - Range setting for Lower LBA bound. |
| | | If Lower bound equals Upper bound then all |
| | | LBAs will be protected. |
| | | [63-49] - reserved |
| 0Ah- | Upper LBA | Bit Description: |
| 0Dh | Bound | [48:0] - Range setting for Upper LBA bound. |
| | | If Upper bound equals Lower bound then all |
| | | LBAs will be protected. |
| | | [63-49] - reserved |
| 0Eh | DoS Enable | Bit Description: |
| | | [0] - 0 Disable Denial of Service (DoS), 1 |
| | | Enable DoS |
| | | [15-1] - reserved |
| 0Fh- | Password | 32 bytes. Can be either User or Master password |
| 17h | | that has been set by SECURITY SET PASSWORD |
| | | command |

Referring now to Table 2, shown is example pseudo-code to calculate a current read/write ratio and store in a non-volatile memory.

TABLE 2

| | |
|---|---|
| enum Type | |
| { | |
| NONE, | |
| READ, | //Reads more frequent |
| WRITE | //Writes more frequent |
| }; | |

```
void smart_workload_ratio_setup_command( )
{
    int ratio_value = 0;
    bool feature_enabled = false;
    Type ratio_type = Type.NONE;
    if ((Password == USER_PASSWORD) || (Password ==
MASTER_PASSWORD){
        if ((Read_Count != 0) && (Write_Count != 0) &&
        (Enable == 1)) {
```

```
enable_feature = true;
if (Read_Count > Write_Count){
    ratio_value = read_count / write_count;
    ratio_type = Type.READ;
}
else{
    ratio_value = write_count / read_count;
    ratio_type = Type.WRITE;
}
```

```
        }
    }
    saveExpectedRatioInFlash(feature_enabled, ratio_value, ratio_type,
ratio_tolerance, lower_lba_bound, upper_lba_bound, dos_enable);
}
```

In addition to the setup command, a pause/resume command shown in Table 3 below, can be used. This feature may be useful for events that could cause false positives to pause the workload analysis logic and resume when complete. It is assumed that the event issuing this command is part of the TCB since the command is password protected.

TABLE 3

| Word | Name | Description |
|---|---|---|
| 00h | Feature | E1h - SMART WORKLOAD RATIO PAUSE |
| | | RESUME |
| 01h | Pause | Bit Description: |
| | | [0] - 0 Resume, 1 Pause. Default value is 0. |
| | | [15:1] - reserved |
| 02h- | Password | 32 bytes. Can be either User or Master password |
| 0Ah | | that has been set by SECURITY SET PASSWORD |
| | | command |

In an embodiment, the logic may monitor the following commands (of course embodiments are not limited to this list): READ DMA; READ MULTIPLE; READ SECTOR(S); WRITE DMA; WRITE MULTIPLE; and WRITE SECTOR(S).

Each access command provides a logical sector count (and starting logical block address) that can be used to calculate the current workload ratio. For simplicity, assume this information is in a consistent format for each command, which can be determined by a single function call. The following example pseudo-code of Table 4 provides an example of how the current workload ratio is calculated and compared with the expected ratio, in an embodiment.

```
TABLE 4
static int globalReadCount = 1;
static int globalWriteCount = 1;
bool isWorkloadInExpectedRange(Type cmdtype)
{
    if (isFeatureEnabled( ) == false){
        return true; //feature is not enable
    }
    if (isLBAwithinProtectionRange( ) == false){
        return true; //I/O request is out of protection range
    }
    int expected_ratio_value = getExpectedRatioValue( );
    type ratio_type = getRatioType( );
    float min_ratio = (1 / getRatioValue( )) − getRatioTolerance( );//min tolerance
    float max_ratio = (1 / getRatioValue( )) + getRatioTolerance( );//max tolerance
    float current_ratio = 0;
    int count = getLogicalSectorCount( ); //# of requested sectors
    if (cmdtype == Type.READ){ //read request
      if (globalReadCount > (count + globalReadCount)){ //check int roll-over
        globalReadCount = globalReadCount − globalWriteCount; //reset cnts
        globalWriteCount = 1;
      }
      globalReadCount += count; //update read counter
      if (ratio_type == Type.READ){ //Workload has more frequent reads
        current_ratio = globalWriteCount / globalReadCount( );
        if ((current_ratio <= min_ratio) || (current_ratio = > max_ratio)){
          return false; //tamper detected
        }
      }
      else{ //Workload has more frequent writes
          current_ratio = globalReadCount / globalWriteCount( );
          if ((current_ratio <= min_ratio) || (current_ratio = > max_ratio)){
            return false; //tamper detected
          }
      }
    }
    else{ //write request
      if(globalWriteCount > (count + globalWriteCount)){ //check int roll-over
        globalWriteCount = globalWriteCount − globalReadCount; //reset
        globalReadCount = 1;
      }
      globalWriteCount += count; //update write counter
      if (ratio_type == Type.READ){ //workload is more read-based
        current_ratio = globalWriteCount / globalReadCount( );
        if ((current_ratio <= min_ratio) || (current_ratio = > max_ratio)){
          return false; //tamper detected
        }
      }
      else{ //workload is more write-based
        current_ratio = globalReadCount / globalWriteCount( );
        if ((current_ratio <= min_ratio) || (current_ratio = > max_ratio)){
            return false; //tamper detected
        }
      }
    }
    return true; //no tamper
}
```

If the current ratio does not match the expected ratio, the controller may be configured to immediately enter into a tampered state, and set a tamper status flag, which can be polled by issuing the following command of Table 5.

TABLE 5

| Word | Name | Description |
|---|---|---|
| 00h | Feature | E2h - SMART TAMPER STATE STATUS |
| 01h | Tamper | Bit Description: |
| | Status | [0] - 0 No tamper detected, 1 Tamper detected. |
| | | This is read-only. |
| | | [15:1] - reserved |

Additionally, a denial of service (DoS) action can be taken, if enabled in the SMART WORKLOAD RATIO SETUP command.

Referring now to Table 6, shown is example pseudo-code for entering a protected mode in accordance with an embodiment of the present invention.

```
TABLE 6
void ATAcommandloop( )
{
    int newcommand = 0;
    bool status = true;
    if ((getTamperBitFlagFromFlash( ) == true) &&
    (SMART_WORKLOAD_RATIO_SETUP.DoS_Enable == 1)){
        tamperStateWithDoS( ); //tamper detected from previous boot
and DoS
        return;
    }
    do{
        newcommand = waitForNewCommand( );
        if (isSMARTworkloadRatioEnabled( ) == true){
            if ((newcommand == READ_DMA) ||
                (newcommand == READ_MULTIPLE) ||
                (newcommand == READ_SECTORS))
            {
                status = isWorkloadInExpectedRange(Type.READ);
            }
            if ((newcommand == WRITE_DMA) ||
                (newcommand == WRITE_MULTIPLE) ||
                (newcommand == WRITE_SECTORS))
            {
                status = isWorkloadInExpectedRange(Type.WRITE);
            }
            if (status == false){
                //tamper is detected, enter tamper state
                setTamperBitFlagInFlash( ); //persists across power
                if (SMART_WORKLOAD_RATIO_SETUP.
DoS_Enable == 1)
                {
                    tamperStateWithDoS( );//enter tamper DoS
                }
            }
        }
        normalProcessATACommand( ); //normal path
    } while (1);
}
```

In an embodiment, an authorized user (e.g., as determined by provision of a User or Master password provided by the command SECURITY SET PASSWORD) can cause an exit from protected mode using a vendor defined command having the format shown in Table 7, and which may be used in the example pseudo-code of Table 8 for exiting protected mode.

TABLE 7

| Word | Name | Description |
|---|---|---|
| 00h | Feature | E3h - SMART EXIT PROTECTION MODE |
| 01h- | Password | 32 bytes. Can be either User or Master password |
| 10h | | that has been set by SECURITY SET PASSWORD |
| | | command |

```
TABLE 8
void tamperStateWithDoS( )
{
    int newcommand = 0;
    bool status = true;
    do
    {
      newcommand = waitForNewCommand( );
      if (newcommand == SMART_EXIT_PROTECTION_MODE){
        if ((Password == USER_PASSWORD) || (Password ==
        MASTER_PASSWORD){
          clearTamperBitFlagInFlash( );
          reboot( );
          return;
        }
    }
    }while (1);
}
```

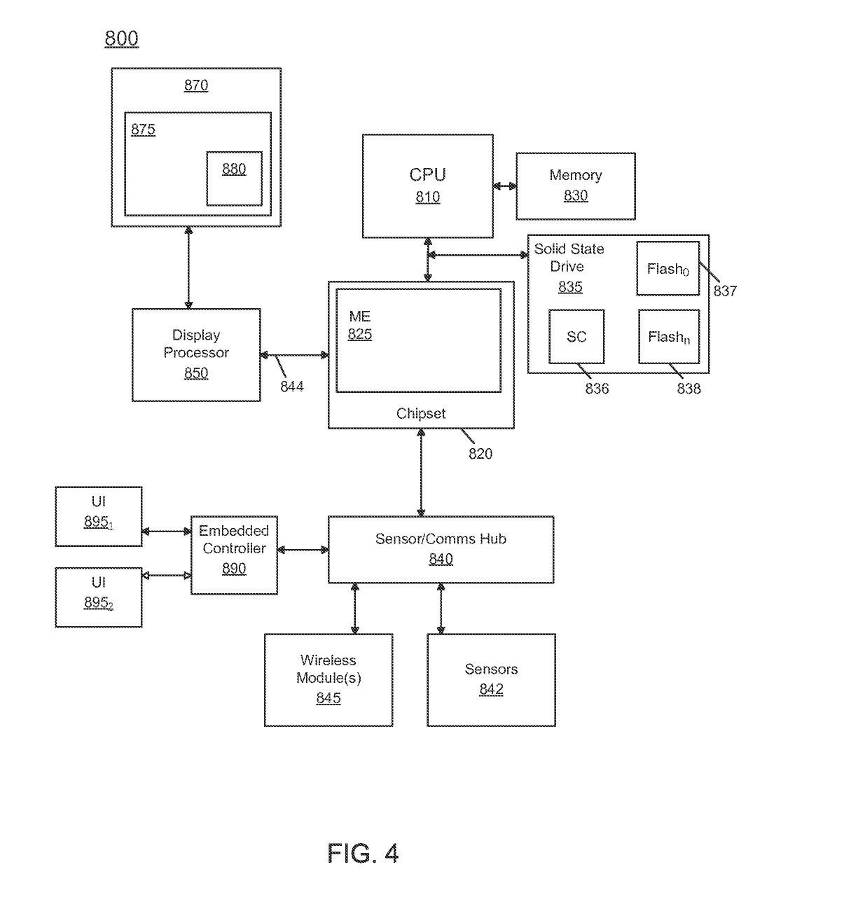

Embodiments may be implemented in a variety of systems, as described above. Referring now to FIG. 4, shown is a block diagram of a system arrangement in accordance with an embodiment of the present invention. As seen in FIG. 4, system 800 may be a user platform such as a mobile device, tablet, phablet, personal computer (or other form factor) and includes a CPU 810. In various embodiments, this CPU may be a SoC or other multicore processor and can include secure execution technologies to set up a trusted execution environment (TEE). In different embodiments, the TEE may be implemented using Intel® SGX technology, Intel® TXT technology, or an ARM TrustZone.

As seen in the embodiment of FIG. 4, CPU 810 may be coupled to a chipset 820. Although shown as separate components in the embodiment of FIG. 4, understand that in some implementations chipset 820 may be implemented within the same package as CPU 810, particularly when the CPU is implemented as an SoC. Chipset 820 may include a manageability engine 825. As further seen, various portions of a memory system couple to CPU 810, including a system memory 830 (e.g., formed of dynamic random access memory (DRAM)) and a solid-state drive 835, at least portions of which may be a secure storage (e.g., by allocation of one or more of individual flash memories 837 and 838) to store sensitive information including personally identifiable information, financial information, personal pictures and so forth. As seen, solid-state drive 835 includes a storage controller 836, which may be configured to perform the workload-based protection described herein.

In the embodiment of FIG. 4, additional components may be present including a sensor/communications hub 840 which may be a standalone hub or configured within chipset 820. As seen, one or more sensors 842 may be in communication with hub 840. For purposes of user authentication and device/context attestation, such sensors can include biometric input sensors, one or more motion sensor devices, and a global positioning system (GPS) module or other dedicated location sensor. In an embodiment, other sensors such as inertial and environmental sensors also may be present. As several examples, an accelerometer and a force detector may be provided and information obtained from these sensors can be used for the motion-based authentications described herein. Also, in various embodiments one or more wireless communication modules 845 may be present to enable communication with local or wide area wireless networks such as a given cellular system in accordance with a 3G or 4G/LTE communication protocol.

As further seen in FIG. 4, platform 800 may further include a display processor 850 that can be coupled to chipset 820 via channel 844, which may be a trusted channel, in some embodiments. As seen, display processor 850 may couple to a display 870 that can be a touch screen display to receive user input such as responses to authentication requests. Thus in this example, configured within the display may be a touch screen 875 and a touch screen controller 880 (which of course is hidden behind the display itself). Other user interfaces, namely user interfaces 895₁ and 895₂ which in an example can be a keyboard and a mouse, may be coupled via an embedded controller 890 to sensor/communications hub 830.

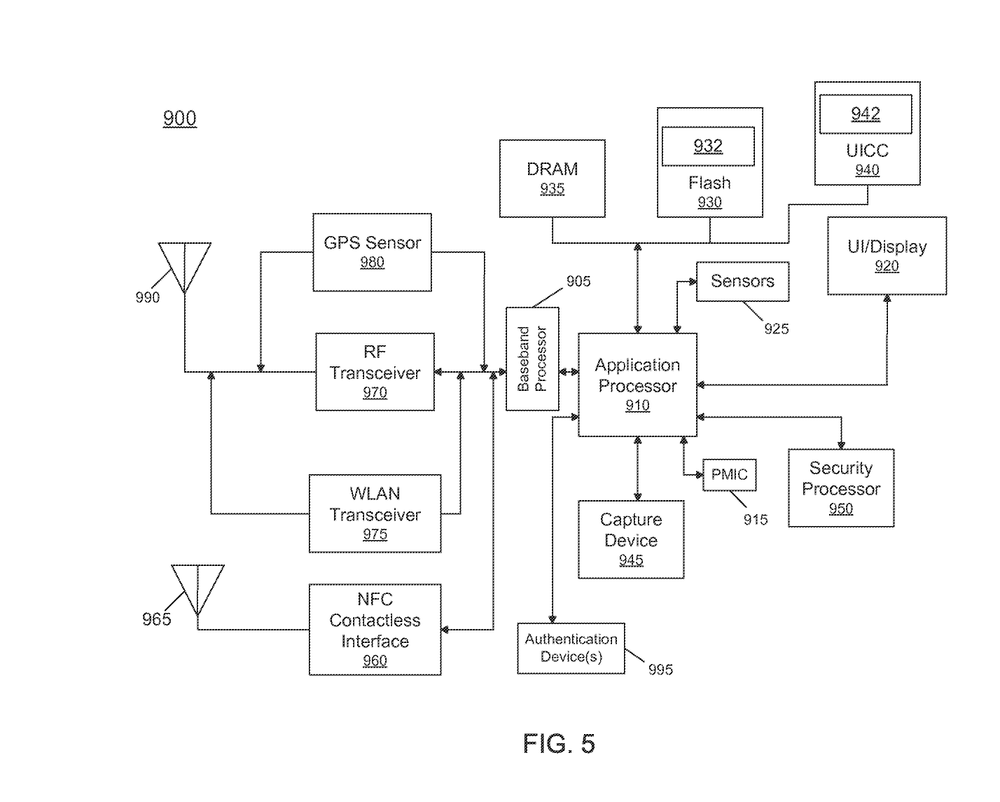

Referring now to FIG. 5, shown is a block diagram of another example system with which embodiments can be used. As seen, system 900 may be a smartphone or other wireless communicator. A baseband processor 905 is configured to perform various signal processing with regard to communication signals to be transmitted from or received by the system. In turn, baseband processor 905 is coupled to an application processor 910, which may be a main CPU of the system to execute an OS and other system software, in addition to user applications such as many well-known social media and multimedia apps. Application processor 910 may further be configured to perform a variety of other computing operations for the device.

In turn, application processor 910 can couple to a user interface/display 920, e.g., a touch screen display. In addition, application processor 910 may couple to a memory system including a non-volatile memory, namely a flash memory 930 and a system memory, namely a DRAM 935. In some embodiments, flash memory 930 may include a secure portion 932 in which secrets and other sensitive information may be stored. In turn, a storage controller of flash 930 may analyze incoming requests as described herein to determine whether a malware attack is underway and if so, to prevent access to (at least) secure portion 932. As further seen, application processor 910 also couples to a capture device 945 such as one or more image capture devices that can record video and/or still images.

Still referring to FIG. 5, a universal integrated circuit card (UICC) 940 comprises a subscriber identity module, which in some embodiments includes a secure storage 942 to store secure user information. System 900 may further include a security processor 950 that may couple to application processor 910. A plurality of sensors 925, including one or more multi-axis accelerometers may couple to application processor 910 to enable input of a variety of sensed information such as motion and other environmental information. In addition, one or more authentication devices 995 may be used to receive, e.g., user biometric input for use in authentication operations.

As further illustrated, a near field communication (NFC) contactless interface 960 is provided that communicates in a NFC near field via an NFC antenna 965. While separate antennae are shown in FIG. 5, understand that in some implementations one antenna or a different set of antennae may be provided to enable various wireless functionality.

A power management integrated circuit (PMIC) 915 couples to application processor 910 to perform platform level power management. To this end, PMIC 915 may issue power management requests to application processor 910 to enter certain low power states as desired. Furthermore, based on platform constraints, PMIC 915 may also control the power level of other components of system 900.

To enable communications to be transmitted and received, various circuitry may be coupled between baseband processor 905 and an antenna 990. Specifically, a radio frequency (RF) transceiver 970 and a wireless local area network (WLAN) transceiver 975 may be present. In general, RF transceiver 970 may be used to receive and transmit wireless data and calls according to a given wireless communication protocol such as 3G or 4G wireless communication protocol such as in accordance with a code division multiple access (CDMA), global system for mobile communication (GSM), long term evolution (LTE) or other protocol. In addition a GPS sensor 980 may be present, with location information being provided to security processor 950 for use as described herein when context information is to be used in a pairing process. Other wireless communications such as receipt or transmission of radio signals, e.g., AM/FM and other signals may also be provided. In addition, via WLAN transceiver 975, local wireless communications, such as according to a Bluetooth™ or IEEE 802.11 standard can also be realized.

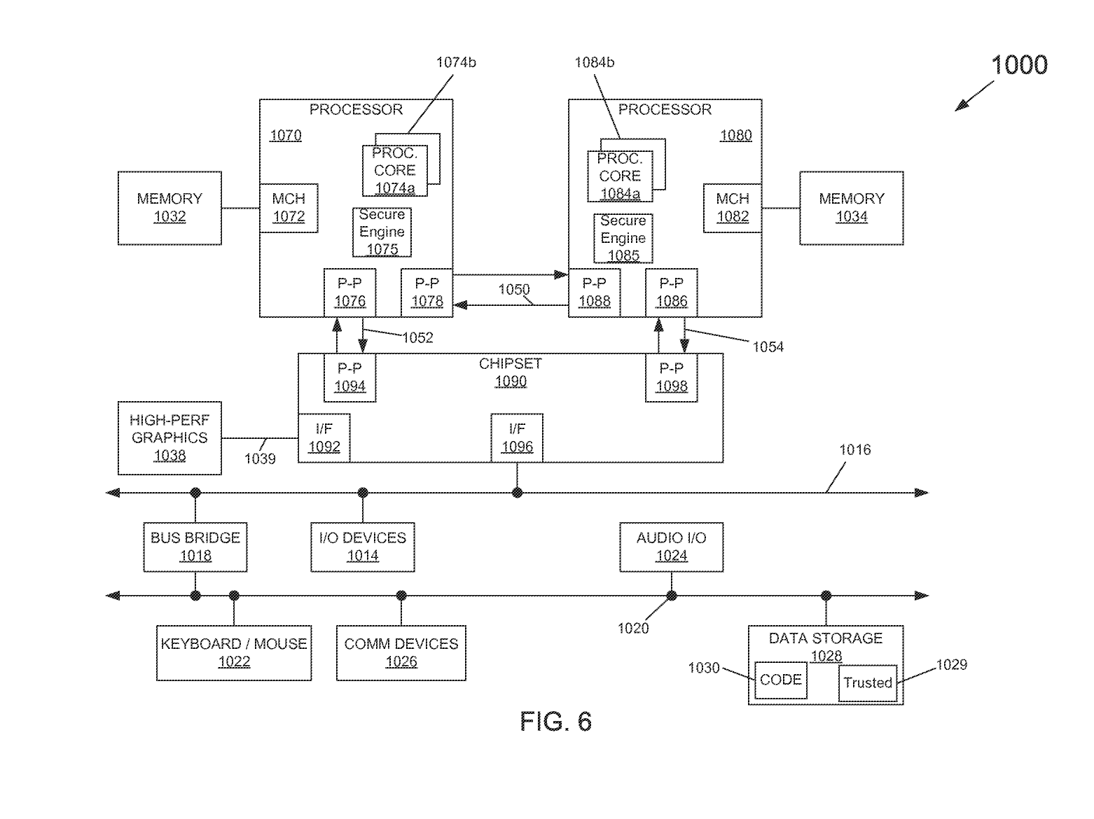

Referring now to FIG. 6, shown is a block diagram of a system in accordance with another embodiment of the present invention. As shown in FIG. 6, multiprocessor system 1000 is a point-to-point interconnect system such as a server system, and includes a first processor 1070 and a second processor 1080 coupled via a point-to-point interconnect 1050. As shown in FIG. 6, each of processors 1070 and 1080 may be multicore processors such as SoCs, including first and second processor cores (i.e., processor cores 1074a and 1074b and processor cores 1084a and 1084b), although potentially many more cores may be present in the processors. In addition, processors 1070 and 1080 each may include a secure engine 1075 and 1085 to perform security operations.

Still referring to FIG. 6, first processor 1070 further includes a memory controller hub (MCH) 1072 and point-to-point (P-P) interfaces 1076 and 1078. Similarly, second processor 1080 includes a MCH 1082 and P-P interfaces 1086 and 1088. As shown in FIG. 6, MCH's 1072 and 1082 couple the processors to respective memories, namely a memory 1032 and a memory 1034, which may be portions of main memory (e.g., a DRAM) locally attached to the respective processors. First processor 1070 and second processor 1080 may be coupled to a chipset 1090 via P-P interconnects 1052 and 1054, respectively. As shown in FIG. 6, chipset 1090 includes P-P interfaces 1094 and 1098.

Furthermore, chipset 1090 includes an interface 1092 to couple chipset 1090 with a high performance graphics engine 1038, by a P-P interconnect 1039. In turn, chipset 1090 may be coupled to a first bus 1016 via an interface 1096. As shown in FIG. 6, various input/output (I/O) devices 1014 may be coupled to first bus 1016, along with a bus bridge 1018 which couples first bus 1016 to a second bus 1020. Various devices may be coupled to second bus 1020 including, for example, a keyboard/mouse 1022, communication devices 1026 and a data storage unit 1028 such as a non-volatile storage or other mass storage device having a storage controller to analyze incoming requests and apply a security policy on detection of variance of a calculated ratio to an expected ratio for a given workload. As seen, data storage unit 1028 may include code 1030, in one embodiment. As further seen, data storage unit 1028 also includes a trusted storage 1029 to store sensitive information to be protected, as described herein. Further, an audio I/O 1024 may be coupled to second bus 1020.

The following Examples pertain to further embodiments.

In Example 1, an apparatus comprises: a storage controller to couple to a storage device. The storage controller may include: a first counter to maintain a first count of incoming read requests to the storage device; a second counter to maintain a second count of incoming write requests to the storage device; and a workload analysis logic to calculate a workload ratio based at least in part on the first count and the second count, compare the workload ratio to an estimated workload ratio, and issue a tamper alert based at least in part on the comparison.

In Example 2, the workload analysis logic is to issue the tamper alert if the workload ratio varies from the estimated workload ratio by at least a threshold amount.

In Example 3, the storage controller is to issue the tamper alert to a baseband management controller coupled to the storage device, to enable a system administrator to be informed of the tamper alert.

In Example 4, the storage controller is to perform a denial of service responsive to the tamper alert, based on a policy setting of a configuration register.

In Example 5, the storage controller is to update the first count responsive to an incoming read request if the incoming read request is within a first address range of the storage device, the first address range defined in one or more configuration registers, and otherwise to not update the first count.

In Example 6, the storage device comprises a storage device of a data server of a data center, the data server configured to perform a first workload having a predefined workload signature, the estimated workload ratio based on the predefined workload signature.

In Example 7, the storage controller is to disable the workload analysis logic for a first workload and enable the workload analysis logic for a second workload.

In Example 8, the storage controller comprises a firmware control logic, the firmware control logic inaccessible to malware.

In Example 9, a method comprises: identifying an incoming request in a controller of a storage device; updating one of a first count stored in a first counter and a second count stored in a second counter based on whether the incoming request is a write request or a read request; calculating a ratio based on the first count and the second count; and performing a security operation on the storage device responsive to the ratio being at least a threshold amount at variance with an estimated ratio.

In Example 10, the method further comprises storing the estimated ratio in a configuration storage of the controller of the storage device.

In Example 11, the method further comprises allowing the incoming request to be provided to a storage unit of the storage device responsive to the ratio being within the threshold amount of the estimated ratio.

In Example 12, the method further comprises issuing a tamper alert responsive to the ratio being at least the threshold amount at variance with the estimated ratio.

In Example 13, the security operation is to prevent a plurality of incoming requests from being provided to a storage unit of the storage device after the tamper alert is issued.

In Example 14, the method further comprises allowing a second plurality of incoming requests to be provided to the storage unit of the storage device, after the tamper alert is cleared responsive to an input from an authorized user.

In Example 15, the storage device comprises a solid-state drive and the estimated ratio is associated with a first workload to be executed on the system including the solid-state drive.

In Example 16, the method further comprises updating the one of the first count and the second count when an address of the incoming request is within a first address range, and otherwise not updating the one of the first count and the second count and directly send the request to a storage unit of the storage device.

In another example, a computer readable medium including instructions is to perform the method of any of the above Examples.

In another example, a computer readable medium including data is to be used by at least one machine to fabricate at least one integrated circuit to perform the method of any one of the above Examples.

In another example, an apparatus comprises means for performing the method of any one of the above Examples.

In Example 17, a system comprises: a processor to execute instructions; a first controller coupled to the processor; and a storage device coupled to the first controller. In this Example, the storage device comprises: a first counter to maintain a first count of incoming read requests to the storage device, the incoming read requests associated with a first workload; a second counter to maintain a second count of incoming write requests to the storage device, the incoming write requests associated with the first workload; and a storage controller to determine a calculated ratio based at least in part on the first count and the second count, compare the calculated ratio to an estimated ratio associated with the first workload, and cause a security operation to occur responsive to the calculated ratio varying from the estimated ratio by at least a threshold amount. The system may further include a plurality of storage units coupled to the storage controller to store information.

In Example 18, the storage controller is to update the first count responsive to an incoming read request associated with the first workload if the incoming read request is within a first address range defined in one or more configuration registers, and otherwise to not update the first count.

In Example 19, the storage controller is to determine the security operation based on a security policy, and where the security operation is to prevent a plurality of incoming requests from being provided to the plurality of storage units responsive to the calculated ratio varying from the estimated ratio by at least the threshold amount.

In Example 20, the storage controller is to enable a second plurality of incoming requests to be provided to the plurality of storage units, after receipt of a user input received responsive to communication of a tamper alert to the user, the communication of the tamper alert responsive to the calculated ratio varying from the estimated ratio by at least the threshold amount.

In Example 21, an apparatus comprises: means for identifying an incoming request in a controller of a storage device; means for updating one of a first count stored in a first counter and a second count stored in a second counter based on whether the incoming request is a write request or a read request; means for calculating a ratio based on the first count and the second count; and means for performing a security operation on the storage device responsive to the ratio being at least a threshold amount at variance with an estimated ratio.

In Example 22, the apparatus further comprises means for storing the estimated ratio in a configuration storage of the controller of the storage device.

In Example 23, the apparatus further comprises means for allowing the incoming request to be provided to a storage unit of the storage device responsive to the ratio being within the threshold amount of the estimated ratio.

In Example 24, the apparatus further comprises means for issuing a tamper alert responsive to the ratio being at least the threshold amount at variance with the estimated ratio.

In Example 25, the apparatus further comprises means for allowing a second plurality of incoming requests to be provided to the storage unit of the storage device, after the tamper alert is cleared responsive to an input from an authorized user.

In Example 26, the apparatus further comprises means for updating the one of the first count and the second count when an address of the incoming request is within a first address range of the storage device, and otherwise not updating the one of the first count and the second count and directly sending the request to a storage unit of the storage device.

Understand that various combinations of the above examples are possible.

Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
a storage controller to couple to a storage device, the storage controller including:
a first counter to maintain a first count of incoming read requests to the storage device;
a second counter to maintain a second count of incoming write requests to the storage device; and
a workload analysis logic to calculate a workload ratio based at least in part on the first count and the second count, compare the workload ratio to an estimated workload ratio, and issue a tamper alert based at least in part on the comparison.

2. The apparatus of claim 1, wherein the workload analysis logic is to issue the tamper alert if the workload ratio varies from the estimated workload ratio by at least a threshold amount.

3. The apparatus of claim 1, wherein the storage controller is to issue the tamper alert to a baseband management controller coupled to the storage device, to enable a system administrator to be informed of the tamper alert.

4. The apparatus of claim 1, wherein the storage controller is to perform a denial of service responsive to the tamper alert, based on a policy setting of a configuration register.

5. The apparatus of claim 1, wherein the storage controller is to update the first count responsive to an incoming read request if the incoming read request is within a first address range of the storage device, the first address range defined in one or more configuration registers, and otherwise to not update the first count.

6. The apparatus of claim 1, wherein the storage device comprises a storage device of a data server of a data center, the data server configured to perform a first workload having a predefined workload signature, the estimated workload ratio based on the predefined workload signature.

7. The apparatus of claim 1, wherein the storage controller is to disable the workload analysis logic for a first workload and enable the workload analysis logic for a second workload.

8. The apparatus of claim 1, wherein the storage controller comprises a firmware control logic, the firmware control logic inaccessible to malware.

9. At least one computer readable storage medium comprising instructions that when executed enable a system to:
identify an incoming request in a controller of a storage device;
update one of a first count stored in a first counter and a second count stored in a second counter based on whether the incoming request is a write request or a read request;
calculate a ratio based on the first count and the second count; and
perform a security operation on the storage device responsive to the ratio being at least a threshold amount at variance with an estimated ratio.

10. The at least one computer readable storage medium of claim 9, further comprising instructions that when executed enable the system to store the estimated ratio in a configuration storage of the controller of the storage device.

11. The at least one computer readable storage medium of claim 9, further comprising instructions that when executed enable the system to allow the incoming request to be provided to a storage unit of the storage device responsive to the ratio being within the threshold amount of the estimated ratio.

12. The at least one computer readable storage medium of claim 9, further comprising instructions that when executed enable the system to issue a tamper alert responsive to the ratio being at least the threshold amount at variance with the estimated ratio.

13. The at least one computer readable storage medium of claim 12, wherein the security operation comprises to prevent a plurality of incoming requests from being provided to a storage unit of the storage device after the tamper alert is issued.

14. The at least one computer readable storage medium of claim 13, further comprising instructions that when executed enable the system to allow a second plurality of incoming requests to be provided to the storage unit of the storage device, after the tamper alert is cleared responsive to an input from an authorized user.

15. The at least one computer readable storage medium of claim 9, wherein the storage device comprises a solid-state drive and the estimated ratio is associated with a first workload to be executed on the system including the solid-state drive.

16. The at least one computer readable storage medium of claim 9, further comprising instructions that when executed enable the system to update the one of the first count and the second count when an address of the incoming request is within a first address range, and otherwise not update the one of the first count and the second count and directly send the request to a storage unit of the storage device.

17. A system comprising:
a processor to execute instructions;
a first controller coupled to the processor; and
a storage device coupled to the first controller, the storage device comprising:
a first counter to maintain a first count of incoming read requests to the storage device, the incoming read requests associated with a first workload;
a second counter to maintain a second count of incoming write requests to the storage device, the incoming write requests associated with the first workload; and
a storage controller to determine a calculated ratio based at least in part on the first count and the second count, compare the calculated ratio to an estimated ratio associated with the first workload, and cause a security operation to occur responsive to the calculated ratio varying from the estimated ratio by at least a threshold amount; and
a plurality of storage units coupled to the storage controller to store information.

18. The system of claim 17, wherein the storage controller is to update the first count responsive to an incoming read request associated with the first workload if the incoming read request is within a first address range defined in one or more configuration registers, and otherwise to not update the first count.

19. The system of claim 17, wherein the storage controller is to determine the security operation based on a security policy, and wherein the security operation is to prevent a plurality of incoming requests from being provided to the plurality of storage units responsive to the calculated ratio varying from the estimated ratio by at least the threshold amount.

20. The system of claim 19, wherein the storage controller is to enable a second plurality of incoming requests to be provided to the plurality of storage units, after receipt of a user input received responsive to communication of a tamper alert to the user, the communication of the tamper alert responsive to the calculated ratio varying from the estimated ratio by at least the threshold amount.
